(19) United States
(12) Patent Application Publication
(10) Pub. No.: US 2007/0168200 A1
(43) Pub. Date: Jul. 19, 2007

(54) Customer management system

(76) Inventor: Noriyuki Shimizu, Tokyo (JP)

Correspondence Address: WENDEROTH, LIND & PONACK L.L.P., 2033 K. STREET, NW, SUITE 800, WASHINGTON, DC, 20006, US

(21) Appl. No.: 10/586,354

(22) PCT Filed: Jan. 19, 2005
(86) PCT No.: PCT/JP05/00590

§ 371 Date: Jul. 17, 2006

(30) Foreign Application Priority Data
Jan. 19, 2004 (JP) 2004-010442

(51) Int. Cl. G06Q 99/00

(52) U.S. Cl. 705/1

(57) ABSTRACT

In order to provide a customer information control system that allows a manufacturer fabricating network home appliances to perform accurate management of customer information, usage function information, and the like in the usage of a network home appliance, the customer management system according to the present invention is constructed from a management apparatus 210 and a network home appliance 200 connected to each other via the Internet 110. The network home appliance 200 comprises: an IC card reading unit 201 operable to read customer information recorded in an IC card; a transmission record preparing unit 202 operable to prepare a transmission record; a transmission record transmitting unit 203 operable to transmit the transmission record to the management apparatus 210; and a merchandise manufacturing number recording unit 204. The management apparatus 210 comprises: a database updating unit 214 operable to automatically update data recorded in a database; a data analysis unit 215 operable to analyze data by using information recorded in the received transmission record; and a customer database 217, a merchandise database 218, a utilization information database 219, and the like.

### TECHNICAL FIELD

The present invention relates to a customer management system that allows a manufacturer to manage information of a customer who has purchased a network home appliance product.

### BACKGROUND ART

Conventionally, management of customer information on a manufacturer side who manufactures home appliance devices has been performed for example in a method that a copy of guarantee certificate received by an electric appliance store, a sale company, a volume retailer, or the like is collected by the manufacturer so that the customer may be recognized at the time of occurrence of repair work in the manufacturer, or alternatively in a method that customer information is acquired from a credit card company for a customer who has purchased a product by using a credit card.

Then, with recent progress of network technology, network home appliances such as a rice cooker and an air-conditioner having a network function are expected to spread in the future. Conveniences in such network home appliances for users include remote operation from the outside of the home and retrieval of information such as cooking recipes. Another possibility is management of customer information on the manufacturer side by utilizing the characteristics of network home appliances.

Meanwhile, as for the above-mentioned management of customer information, a game machine utilizing customer management system has been disclosed in which marketing information for development of new game machines and introducing of game machines into amusement centers can be acquired and further customers are allowed to refer to their own utilization history of game machines (for example, refer to Patent Document 1).

Further, a network technique for home appliance products has been disclosed in which a plurality of home appliance products of plural kinds of each user can be managed individually and operated by remote control (for example, refer to Patent Document 2).
Patent Document 1: Japanese Laid-Open Patent Application No. H8-224351
Patent Document 2: Japanese Laid-Open Patent Application No. 2002-345051

### DISCLOSURE OF INVENTION

Problems that Invention is to Solve

Nevertheless, in order that customer information should be managed on a manufacturer side of home appliance products or the like, complicated processing such as collection of documents is required as described above, and hence time and effort are necessary. On the other hand, accurate customer information could not be acquired in case of duplicated registration or registration with mistaken information.

Further, on the manufacturer side, customer information can not be acquired such as how frequently and which functions of home appliance devices have been used by actual users ahead of a volume retailer.

Further, the characteristics of network home appliances could be applied and utilized in customer information management on the manufacturer side so that marketing or the like could be achieved. Nevertheless, the above-mentioned Patent Document 1 discloses merely that utilization frequency and actual mode of usage of game machines in an amusement center are utilized for marketing analysis, and does not present a detailed method that what kind of information should be used for the management of customer information of network home appliances.

Further, with the spread of network home appliances described above, a business model of network home appliances could be realized in which home appliance devices are installed in a user's home by rental so that the user is charged in correspondence to the usage status. Nevertheless, a detailed method for this is not presented, neither.

The present invention has been devised in view of the above-mentioned problem. An object of the present invention is to provide a customer management system capable of accurately managing information of customers who have purchased network home appliances as well as usage information.

Means to Solve the Problems

In order to solves the above-mentioned problem, the customer management system according to the present invention is characterized by a customer management system including a home appliance device connectable to a network and a management apparatus which manages information concerning a customer, the home appliance device and the management apparatus being connected to each other via the network, wherein the home appliance device includes: a reading unit which reads the customer information concerning a customer from a recording medium; a manufacturing number recording unit which holds a manufacturing number provided at a time of manufacturing of the home appliance device; a transmission record preparing unit which prepares a transmission record that describes at least one of function information assigned on the basis of a usage form of the home appliance device, the customer information, and the manufacturing number; and a transmitting unit which transmits the transmission record to the management apparatus, and wherein the management apparatus includes: a receiving unit which receives the transmission record; a transmission record reading unit which reads information described in the transmission record; and an analysis unit which analyzes the read information.

Accordingly, the home appliance device that constitutes the customer management system according to the present invention transmits a transmission record to the management apparatus on the manufacturer side. Further, using the customer information and the like recorded in the transmission record, the management apparatus on the manufacturer side can accurately recognize information concerning the customer who uses the home appliance device and information concerning the function.

Further, the management apparatus of the customer management system according to the present invention is characterized by further including: a customer database which holds the customer information recorded in the transmission record having been received; a merchandise database which holds the merchandise information recorded in the transmission record having been received; an analysis information database which holds an analysis result in the analysis unit; and a record updating unit which updates the record of the information recorded in the customer database, the merchandise database, and the analysis information database, after the receiving of the transmission record.

Accordingly, the management apparatus on the manufacturer side can update the customer information, the merchandise information, and the usage status into the newest information at the time of necessity, and then record and manage these pieces of information in the customer database, the merchandise database, and the analysis information database. This permits more accurate recognition of the usage status of the home appliance device.

Further, the home appliance device in the customer management system according to the present invention is characterized by further including a first-time determination unit which determines whether the customer information has been read by the reading unit, at a time of first-time usage, wherein the transmission record preparing unit further prepares a first-time transmission record that includes at least the customer information and the manufacturing number, when the read of the customer information by the reading unit is determined as being the first time by the first-time determination unit, and the transmitting unit transmits the first-time transmission record to the management apparatus.

Further, the home appliance device in the customer management system according to the present invention is characterized by further including a device control unit which brings the home appliance device into a usage permitted state after the first-time transmission record is transmitted by the transmitting unit.

According to these configurations, the first-time determination unit determines whether a first-time transmission record has been transmitted from the home appliance device to the management apparatus side. Then, the device control unit brings the home appliance device into a usage non-permitted state unless the first-time transmission record is transmitted. This allows the management apparatus side to acquire more reliably the information of the customer who uses the home appliance device.

In order to achieve the above-mentioned object, the present invention may be implemented in the form of a home appliance device having constituent means characteristic to the customer management system, or alternatively a management apparatus on the manufacturer side, or alternatively a program including, as its steps, constituent means characteristic to the customer management system. This program may be circulated through a recording medium such as a CD-ROM or alternatively through a communication network.

### EFFECTS OF THE INVENTION

The customer management system according to the present invention always the management apparatus on the manufacturer side to accurately manage information of a customer who uses a home appliance device, merchandise information, and information of utilized functions. Further, when customer information is not registered in the first-time usage of the home appliance device, the home appliance device can be brought into a usage non-permitted state.

Further, information recorded in various kinds of databases in the management apparatus on the manufacturer side is updated automatically. Thus, up-to-date information is always available. Further, this improves customer service like speed up of response to failure of the home appliance device.

### BRIEF DESCRIPTION OF DRAWINGS

FIG. 1 is a general view showing a hardware configuration of a customer management system according to the present invention.

FIG. 2 is a functional block diagram showing a network home appliance in a user's home and a management apparatus on a manufacturer side that constitute a customer management system according to the present invention.

FIG. 3 is a diagram showing an example of a configuration of a transmission record transmitted from a network home appliance that constitutes a customer management system according to the present invention.

FIG. 4 is a diagram showing an example of a data configuration of a table recorded in a database of a management apparatus on a manufacturer side that constitutes a customer management system according to the present invention.

FIG. 5 is a flow chart showing an operation procedure on a home appliance device side that constitutes a customer management system according to the present invention.

FIG. 6 is a flow chart showing an operation procedure of a management apparatus on a manufacturer side that constitutes a customer management system according to the present invention.

FIG. 7 is an example of screen display on a management apparatus on a manufacturer side that constitutes a customer management system according to the present invention.

FIG. 8 is an example of a screen displayed on a management apparatus on a manufacturer side that constitutes a customer management system according to the present invention.

FIG. 9 is a reference diagram showing other utilization information data tables recorded in a utilization information database of a management apparatus according to the present invention.

FIG. 10 is a reference diagram of a function code list table recorded in a function code list storage unit of a network home appliance.

FIG. 11 is a timing chart showing a communication interval of transmission records transmitted from a network home appliance to a management apparatus.

### NUMERICAL REFERENCES

100 User's home

101a, 102a, 103a, 104a IC card reading unit

110 Internet

120 Manufacturer

121 Management apparatus

122 Server apparatus

200 Network home appliance

201 IC card reading unit

202 Transmission record preparing unit

202a First-time determination unit

202b Function code generating unit

202c IC card information storage unit

202d Function code list storage unit

203 transmission record transmitting unit

204 Merchandise manufacturing number recording unit

205 Apparatus control unit

210 Management apparatus

211 transmission record receiving unit

212 Customer database duplication check unit

213 Database recording unit

214 Data analysis unit

215 Database updating unit

216 Utilization charge calculation unit

217 Customer database

218 Merchandise database

219 Utilization information database

301 First-time transmission record

302 Usage transmission record

401 Customer data table

402 Merchandise data table

403, 900, 901 Utilization information data table

1000, 1001 Function code list table

### BEST MODE FOR CARRYING OUT THE INVENTION

A customer management system according to the present invention is described below with reference to the drawings.

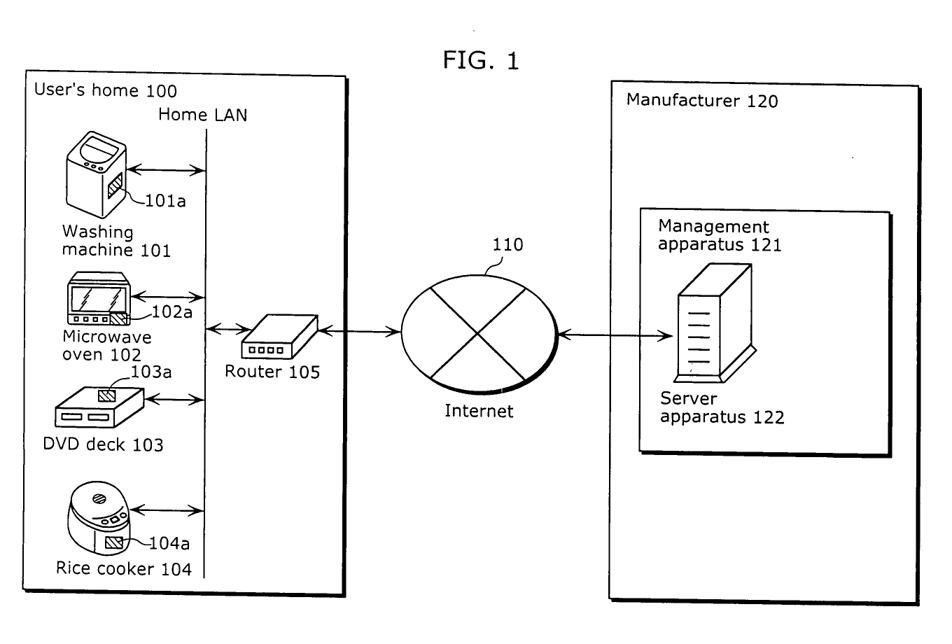

FIG. 1 is a general view showing a hardware configuration of a customer management system according to the present invention.

A user's home 100 serving as a home network and a manufacturer 120 who manufactures home appliance products are connected to each other via the Internet 110.

The user's home 100 is connected to the Internet 110 via a router 105 or the like. Then, through a home LAN, the router 105 is connected to a plurality of network home appliances such as a washing machine 101, a microwave oven 102, a DVD deck 103, and a rice cooker 104. Each network home appliance is provided with an IC card reader 101a, 102a, 103a, or 104a.

On the manufacturer 120 side, customer information is managed by a management apparatus 121 provided with a management server 122. This management apparatus 121 is a PC or the like.

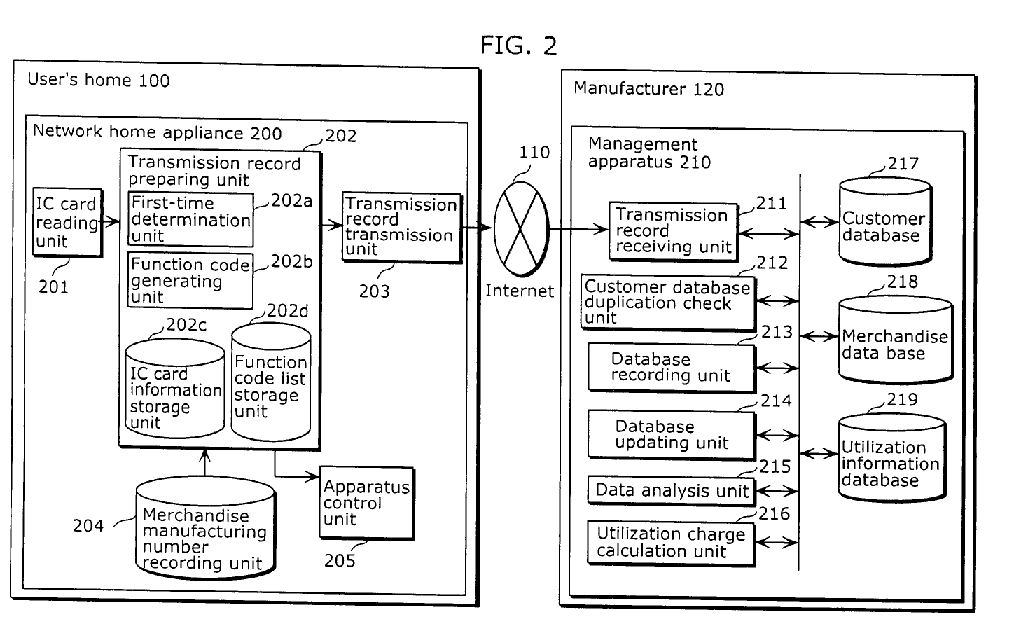

FIG. 2 is a functional block diagram showing a network home appliance 200 in a user's home 100 and a management apparatus 210 on a manufacturer 120 side that constitute a customer management system according to the present invention.

The network home appliance 200 that constitutes the customer management system includes an IC card reading unit 201, a transmission record preparing unit 202, a transmission record transmitting unit 203, and a merchandise manufacturing number recording unit 204.

The IC card reading unit 201 reads customer information recorded in an IC card owned individually by each user. This customer information includes the name, the address, the account number, and the like. Here, the medium read by the IC card reading unit 201 is not limited to an IC card, and may be a credit card on which an IC chip can be mounted. Further, for example, such processing may be performed that when customer information is not registered in the first-time usage in the IC card reading unit 201, the power of the network home appliance 200 becomes ON but its function does not become available. This ensures the customer information to be reliably transmitted to the management apparatus 210 on the manufacturer 120 side, and hence prevents missing of registration of the customer information.

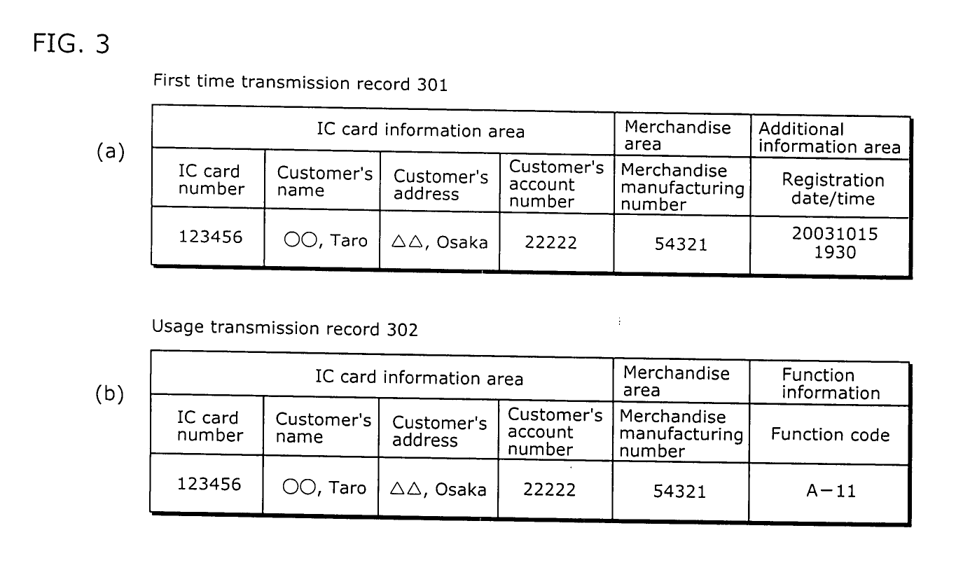

The transmission record preparing unit 202 prepares a transmission record transmitted from the network home appliance 200 to the manufacturer 120 side via the Internet. The data configuration of the prepared transmission record is explained in FIG. 3 described later.

Further, the transmission record preparing unit 202 includes: a first-time determination unit 202a, a function code generating unit 202b, an IC card information storage unit 202c, and a function code list storage unit 202d.

The first-time determination unit 202a determines whether the IC card information read by the IC card reading unit 201 is the first-time one, with reference to IC card information recorded in the IC card information storage unit 202c.

The function code generating unit 202b acquires a function code corresponding to a function used in the network home appliance 200 from the function code list storage unit 202d. Then, the transmission record preparing unit 202 prepares a transmission record by using this acquired function code.

The IC card information storage unit 202c serves as a storage unit such as a hard disk for holding read-out new IC card information in a case that the read of IC card information is determined as being the first time by the first-time determination unit 202a.

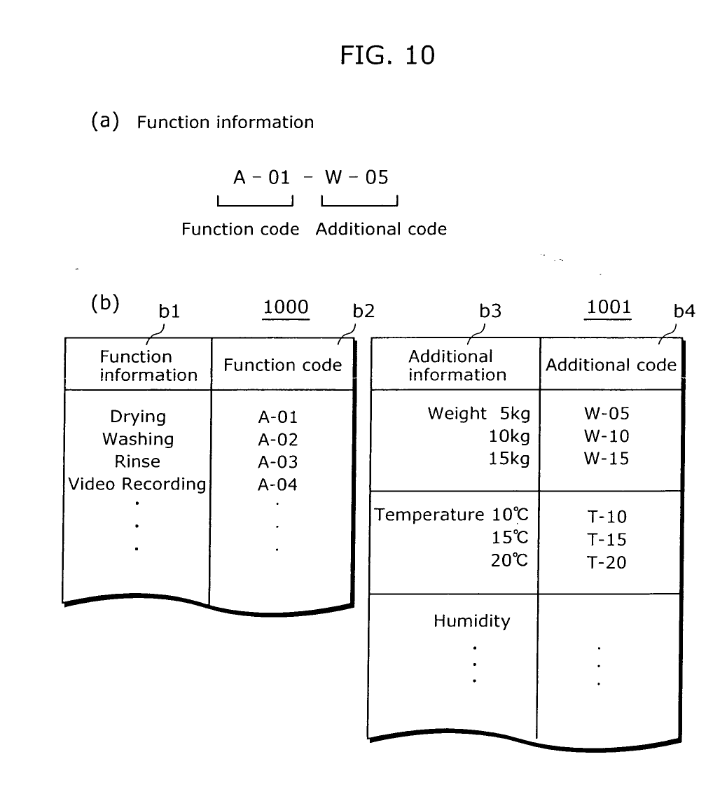

The function code list storage unit 202d is a storage unit holding a function code list table that is provided in advance for example at the time of manufacturing and that lists function codes corresponding to the functions of the network home appliance 200 as explained in FIG. 10 described later.

Here, when IC card information is read that is different from IC card information having been read before, the transmission record preparing unit 202 may for example perform first-time registration in the IC card information storage unit 202c again with considering the information as new customer information.

The transmission record transmitting unit 203 transmits the transmission record prepared by the transmission record preparing unit 202, to the manufacturer 120 side via the Internet.

The merchandise manufacturing number recording unit 204 records a manufacturing number that is provided to each network home appliance 200 at the time of manufacturing and that is globally unique.

In response to an instruction from the first-time determination unit 202a, the apparatus control unit 205 performs control such as to bring the network home appliance 200 into a usage non-permitted state when read of IC card information is not yet performed. Here, in place of bringing into a usage non-permitted state, screen display, basic functions, or the like may solely be brought into a permitted state.

Then, the management apparatus 210 on the manufacturer 120 side that constitutes the customer management system includes a transmission record receiving unit 211, a customer database duplication check unit 212, a database recording unit 213, a database updating unit 214, a data analysis unit 215, a utilization charge calculation unit 216, a customer database 217, a merchandise database 218, and a utilization information database 219.

The transmission record receiving unit 211 receives the transmission record transmitted from the network home appliance 200. The customer database duplication check unit 212 determines whether the customer is a customer already registered in the customer database, by using the information of the IC card number. The database recording unit 213 records data into the customer database 217, the merchandise database 218, and the utilization information database 219. In response to an instruction from the data analysis unit 215, the database updating unit 214 updates the information recorded in the utilization information database 219 at the time of necessity or periodically. This period is one month or the like. The data analysis unit 215 analyzes the information recorded in the transmission record, and thereby analyzes: usage status for each merchandise or each function of the network home appliance 200; situation of possession of home appliance devices for each customer; information for each area; information concerning utilization charge; and the like. The utilization charge calculation unit 216 calculates utilization charge for each customer in a case that, for example, the network home appliance 200 is rented.

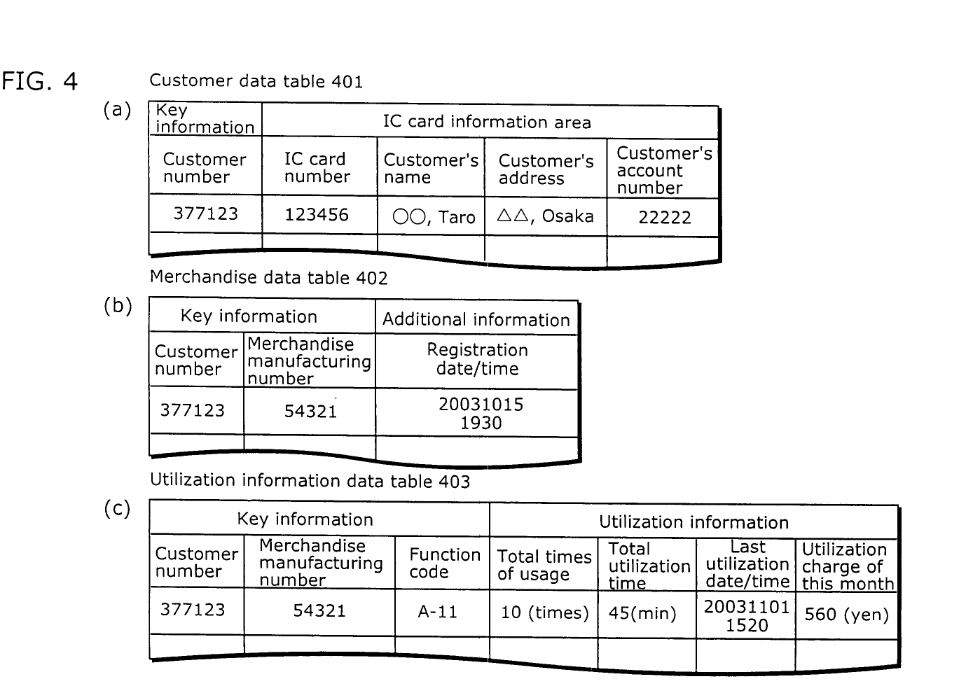

Further, the customer database 217 holds customer information such as the IC card number and the customer number. The merchandise database 218 holds information such as the manufacturing number of a merchandise and the registration date/time. The utilization information database 219 holds utilization information of utilized functions for each customer or for each merchandise analyzed in the data analysis unit. The information recorded in each database is explained in detail in FIG. 4, described later.

Although not shown in FIG. 2, the management apparatus 210 may be provided with a first-time determination unit for determining whether the transmission record transmitted from the network home appliance 200 is a first-time transmission record for first-time registration.

FIG. 3 is a diagram showing an example of a configuration of a transmission record transmitted to the manufacturer 120 side from a network home appliance 200 that constitutes a customer management system according to the present invention.

The first-time transmission record 301 generated in the transmission record preparing unit 202 shown in FIG. 3(a) is information transmitted in the first-time usage after through purchase of the network home appliance 200, and includes an IC card information area, a merchandise area, and an additional information area. For example, the IC card information area describes information concerning an IC card number “123456”, a customer's name “◯◯, Taro”, a customer's address “ΔΔ, Osaka”, and a customer's account number “22222”. The merchandise area describes information concerning a merchandise manufacturing number “54321”. The additional information area describes information concerning registration date/time “Oct. 15, 2003 19:30”.

The usage transmission record 302 shown in FIG. 3(b) includes an IC card information area, a merchandise area, and a function information area. In place of the additional information area recorded in the first-time transmission record, a function code that is function information of the actual usage of the network home appliance is always transmitted during the usage. Here, the first-time transmission record 301 is transmitted at the time of utilization start of the network home appliance 200. Thus, in order to be discriminated from the usage transmission record 302 transmitted at the time of normal usage, the first-time transmission record 301 may be provided with a flag.

FIG. 4 is a diagram showing an example of a data configuration recorded in each database of the management apparatus 210 on the manufacturer side 120 that constitutes the customer management system according to the present invention.

The customer data table 401 recorded in the customer database 217 includes key information and an IC card information area. The key information describes the customer number. The IC card information area describes the IC card number corresponding to the customer number, the customer's name, the customer's address, and the customer's account number.

The merchandise data table 402 recorded in the merchandise database 218 describes key information and additional information. The key information records information concerning the customer number and the merchandise manufacturing number. The additional information records information recorded in the transmission record 301.

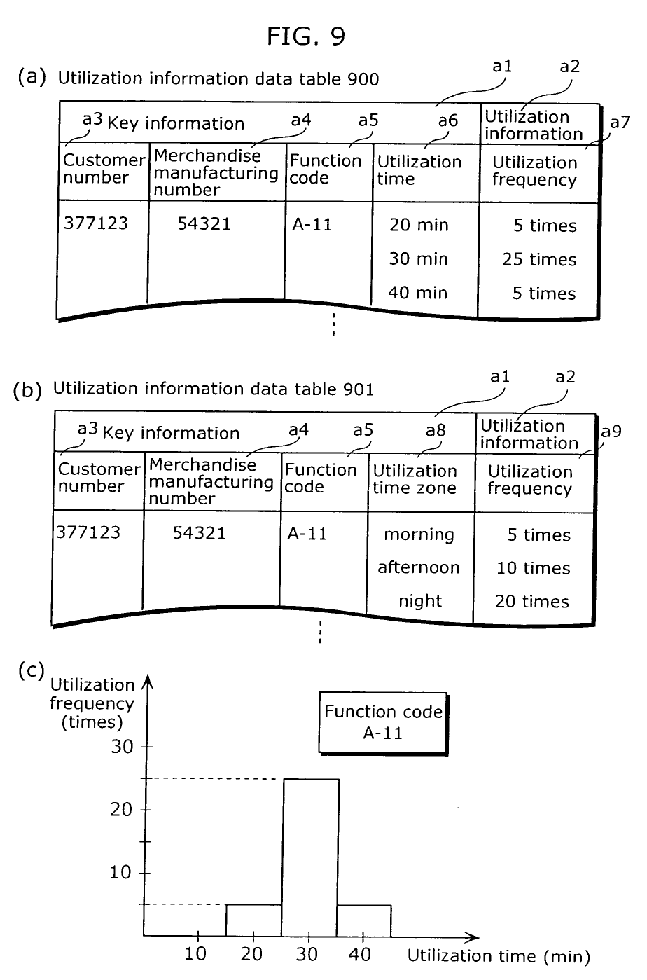

The utilization information data table 403 recorded in the utilization information database 219 records key information, function information, and analysis information. The key information describes the customer number, the merchandise manufacturing number, and the function code information. The analysis information records the analysis result obtained in the data analysis unit 215, and describes for example information such as the total times of usage “10 times”, the total utilization time “45 minutes”, the last utilization date/time, and the utilization charge of this month “560 yen”. Others examples of the utilization information data table recorded in the utilization information database 219 are shown in FIG. 9 described later.

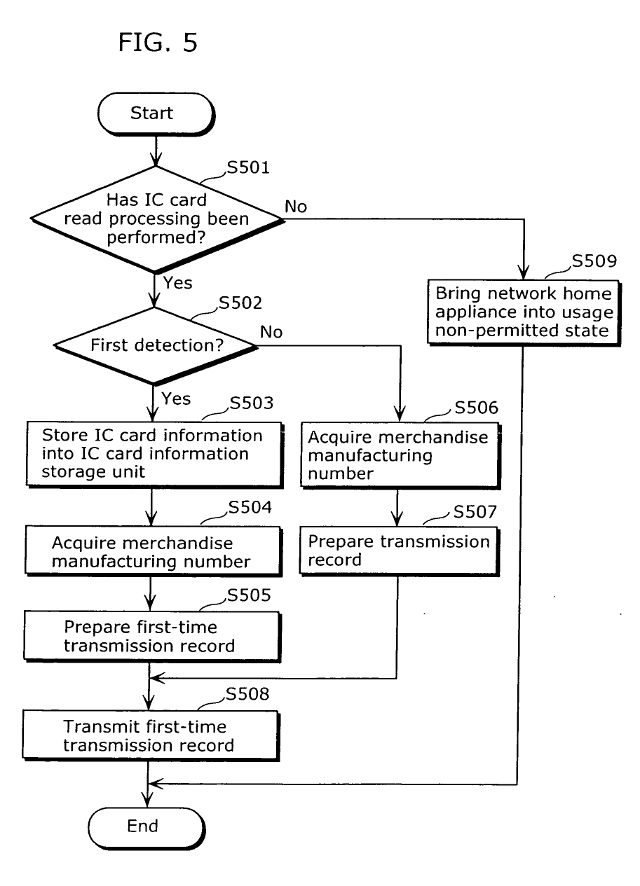

FIG. 5 is a flow chart showing an operation procedure of the network home appliance 200 that constitutes the customer management system according to the present invention. In the description of FIG. 5, the time of new usage start indicates the case that the network home appliance 200 is used at the first time after the purchasing. The time of continued usage indicates the time of usage other than the first-time usage after the purchasing of the network home appliance 200.

First, it is determined whether the IC card reading unit 201 has read an IC card owned by each customer (S501). When the IC card read processing has not been performed (No at S501), in the present invention, the apparatus control unit 205 brings the network home appliance 200 into a utilization non-permitted state, and then the processing is completed (S509). As such, the user cannot use the network home appliance 200 unless customer information is registered into the management apparatus 210 in the first-time usage. Thus, the control by the device control unit 205 according to the present invention becomes effective in a rental business model or the like for the network home appliance 200.

Then, with reference to the IC card information storage unit 202c, the first-time determination unit 202a checks whether the read-out IC card information is the first time detection (S502). Then, when the first-time determination unit 202a has determined as being the first time detection (Yes at S502), processing of storing the IC card information read by the IC card reading unit 201 into the IC card information storage unit 202c is performed (S503).

Then, the transmission record preparing unit 202 acquires a merchandise manufacturing number from the merchandise manufacturing number recording unit 204 (S504), and then performs processing of preparing a first-time transmission record 301 including the customer information obtained from the merchandise manufacturing number and the IC card information (S505).

On the other hand, when it is determined as not being the first time detection (No at S502), the transmission record preparing unit 202 acquires a merchandise manufacturing number from the merchandise manufacturing number recording unit 204 (S506), and then performs processing of preparing a usage transmission record 302 including the customer information and the function information (S507). Then, the transmission record transmitting unit 203 transmits the prepared transmission record to the management apparatus 210 on the manufacturer 120 side (S508), and then a series of processing is completed.

Here, at the time of new usage start, processing is performed such that the IC card reading unit 201 reads the customer information and then the transmission record preparing unit 202 records the customer information into the transmission. However, at the time of continued usage, the customer information need not be transmitted at each time. That is, when the transmission record preparing unit 202 records the merchandise manufacturing number into the transmission record, a home appliance device can be identified that has transmitted the transmission record.

Further, even when it is determined that the IC card information is not read at S501, the apparatus control unit 205 may permit solely the usage of the basic functions such as screen display, in place of bringing the network home appliance 200 into a usage non-permitted state as shown in S509. Further, display may be performed on the screen such as to prompt the user to perform first-time registration of the IC card information.

Further, for example, registration of the customer information into the IC card information recording unit 202c may be performed in advance at the time of purchasing in a volume retailer by using the member's card or the like. Then, in the home, when the network home appliance 200 is connected to a power supply, the customer information already registered may be transmitted automatically to the management apparatus 210 side via an electric wire.

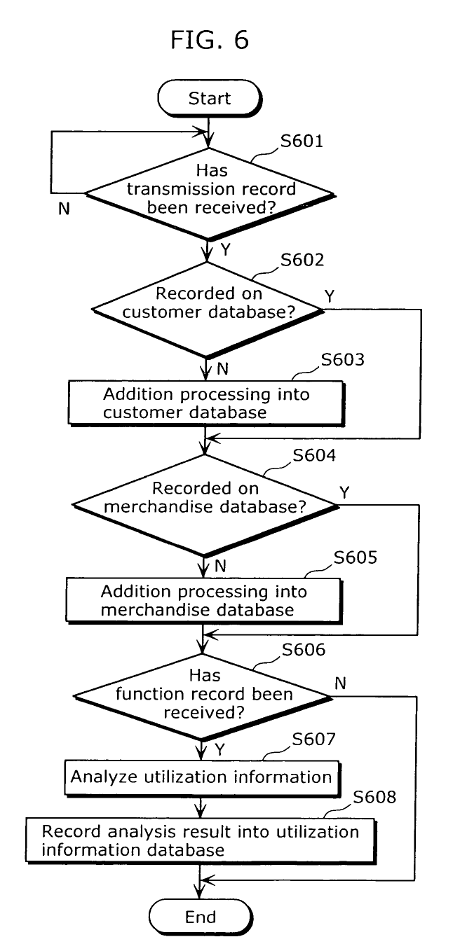

FIG. 6 is a flow chart showing an operation procedure of the management apparatus 210 on the manufacturer 120 side that constitutes the customer management system according to the present invention.

First, it is determined whether the transmission record receiving unit 211 has received a transmission record from the network home appliance 200 (S601).

Then, when the transmission record has been received (Y at S601), the database duplication check unit 212 determines whether the customer is an already-registered customer whose customer information is already described in the customer database 217. Then, when the customer is a new customer whose customer information is not described (N at S602), processing of adding and describing the information into the customer database 217 is performed (S603). On the other hand, when the customer is an already-registered customer whose customer information is already described (Y at S602), it is determined as being continued usage, so that the processing of describing into the customer database 217 is not performed. Then, it is determined whether recorded in the merchandise database 218 (S604).

Then, in the case of not being recorded in the merchandise database 218 (N at S604), the database updating unit 214 performs processing of additional registration (S605). In the case of being recorded in the merchandise database 218 (Y at S604), the processing of additional registration is not performed.

Then, the data analysis unit 215 determines whether function information is included in the transmission record transmitted from the network home appliance 200 (S606). When function information is received (Y at S606), the data analysis unit 215 performs analysis processing for the function codes for each merchandise (S607).

Then, the data analysis unit 215 transmits the analysis result to the database updating unit 214 so that processing of updating the table information recorded in the utilization information database 219 is performed (S608).

On the other hand, when function information is not included in the transmission record (N at S606), the data analysis unit 215 does not perform analysis processing, and then a series of processing is completed.

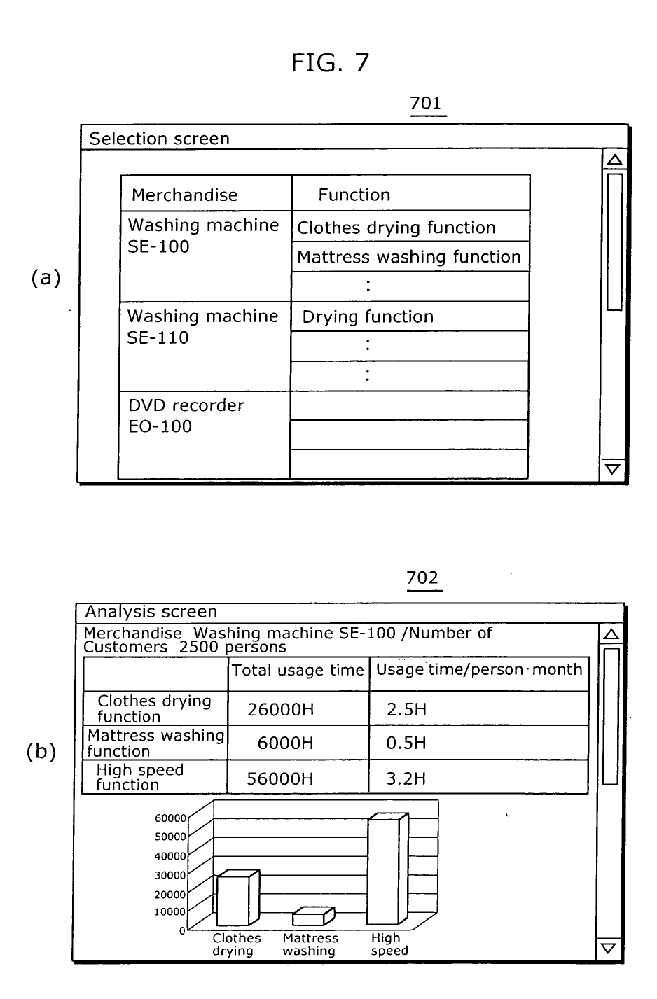

FIG. 7 is an example of screen display on the management apparatus 210 on the manufacturer 120 side that constitutes the customer management system according to the present invention.

On the screen of the management apparatus 210 shown in FIG. 7(a), a selection screen 701 is first displayed that is used for selecting a merchandise, a function, or the like the analysis result of which is required to be displayed. This selection screen 701 displays registered network home appliance types such as a washing machine and a DVD recorder or the functions provided in each home appliance merchandise. Then, the user selects a merchandise or a function the analysis result of which is required to be displayed, by using a cursor or the like on the screen.

Further, the analysis screen 702 shown in FIG. 7(b) displays the result for each merchandise analyzed in the data analysis unit 215. For example, as for a merchandise “washing machine”, the number of customers presently registered in the management apparatus 210 is 2500 persons. Further, as for each function, the information of total usage time and usage time/person·month is displayed for a clothes drying function, a mattress washing function, and a high speed function.

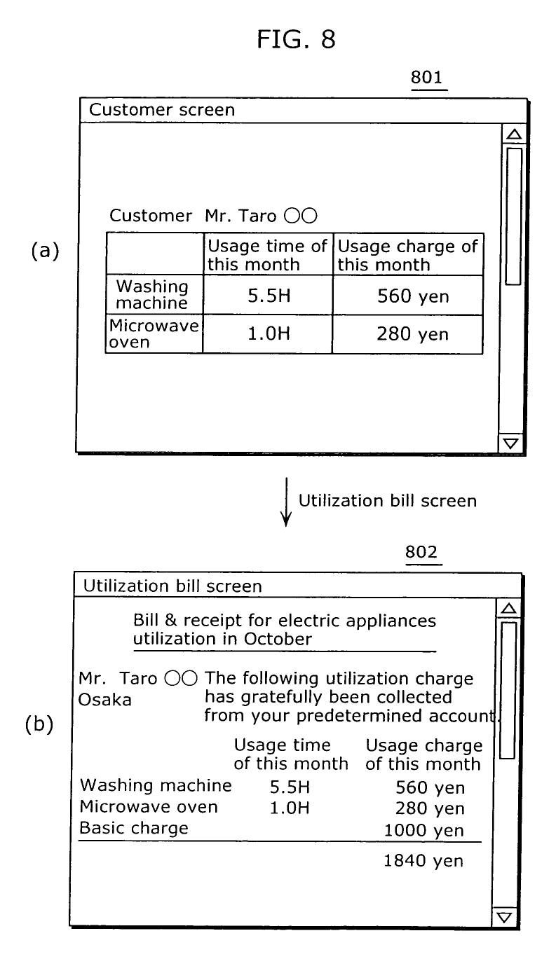

FIG. 8 is an example of a screen displayed on the management apparatus 210 on the manufacturer 120 side that constitutes the customer management system according to the present invention.

The customer screen 801 shown in FIG. 8(a) displays a screen for each customer, and displays utilization charge for each merchandise. For example, the relation between the usage time of this month and the usage charge of this month is displayed for the customer “◯◯, Taro” for the washing machine and the microwave oven. Further, the usage charge may be displayed in correspondence to each function of the merchandise.

Further, the charge calculation screen 802 shown in FIG. 8(b) displays the utilization charge for each customer. Then, for example, displayed are: information of the bill and the receipt of electric appliances utilization in October; and information of the usage time of this month and the usage charge of this month.

FIG. 9 is a reference diagram showing other utilization information data tables 900 and 901 recorded in the utilization information database 219 of the management apparatus 210 according to the present invention.

FIG. 9(a) shows a utilization information data table 900, where key information (a1) and utilization information (a2) are described. The key information (a1) describes the customer number (a3), the merchandise manufacturing number (a4), the function code (a5), and the utilization time (a6). Further, the utilization information (a2) describes the utilization frequency (a7) that corresponds to the utilization time (a6) of the network home appliance 200.

FIG. 9(b) shows a utilization information data table 901, where key information (a1) and utilization information (a2) are described. The key information (a1) describes the customer number (a3), the merchandise manufacturing number (a4), the function code (a5), and the utilization time zone (a8). Further, the utilization information (a2) describes the time zone frequency (a9) that corresponds to the utilization time zone (a8) of the network home appliance 200. These pieces of information concerning the time can be analyzed by the data analysis unit 215 of the management apparatus 210, for example, on the basis of the time that the transmission record transmitted from the network home appliance 200 is received.

FIG. 9(c) is a histogram obtained by the data analysis unit 215 of the management apparatus 210 in the analysis of the utilization time (a6) and the utilization frequency (a7) in the utilization information data table 900 of FIG. 9(a). As shown in this figure, it is confirmed that the utilization time of a function code “A-11” is most frequent at 30 minutes. Then, on the basis of such analysis, information concerning new product development or marketing can be acquired on the management apparatus 210 side.

FIG. 10 is a reference diagram of function code list tables 1000 and 1001 recorded in the function code list storage unit 202 of the network home appliance 200.

FIG. 10(a) shows function information included in the transmission record transmitted from the network home appliance 200, where an additional code is further added to the function code. Further, FIG. 10(b) shows a reference diagram of function code list tables 1000 and 1001, where the function code (b2) corresponding to the function information (by) and the additional code (b4) corresponding to the additional information (b3) are recorded. The additional information (b3) describes for example the information of weight, temperature, humidity, recording amount, and the like for each type.

Then, with referring to these function code list tables 1000 and 1001 recorded in the function code list storage unit 202d, the function code generating unit 202b of the network home appliance 200 acquires the function code corresponding to the usage mode or the usage status of the home appliance device, and thereby generates function information to be imparted to the transmission record. The function information “A-01-W-05” shown in FIG. 10(a) indicates that the drying function of the washing machine was used while the total weight of that wash was 5 kg.

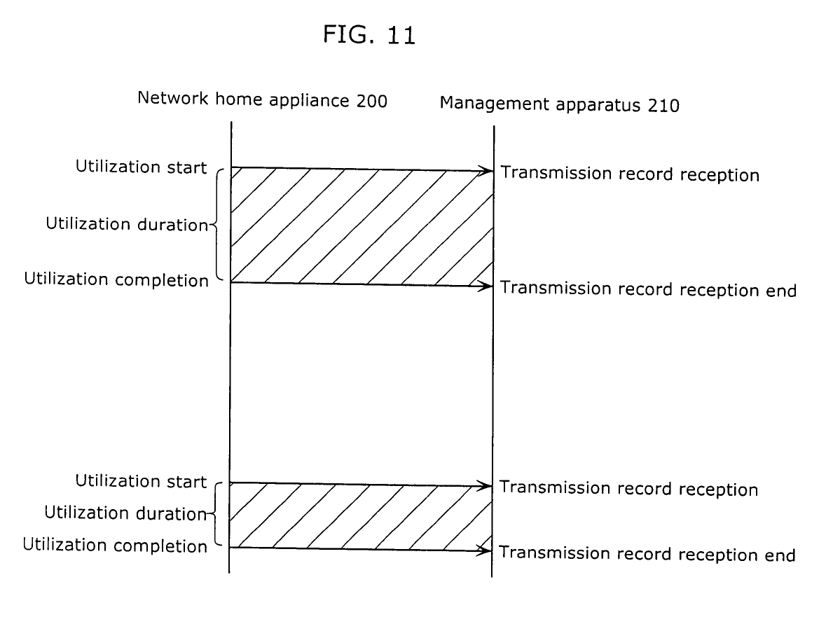

FIG. 11 is a timing chart showing a communication interval of transmission records transmitted from the network home appliance 200 to the management apparatus 210.

For example, the network home appliance 200 is always connected to the network. Then, a transmission record is always transmitted to the management apparatus 210 side from the utilization start time to the utilization completion time of the network home appliance 200. The timing of this transmission may be each time that the user operates an operation button of the network home appliance 200, or alternatively at predetermined intervals (for example, every one minute). The timing chart shown in this figure is an example, and the present invention is not limited to this example.

As described above, in the customer information management system according to the present invention, the IC card reading unit 201 on the network home appliance 200 side reads customer information from an IC card. Then, the transmission record preparing unit 202 prepares a transmission record that records the customer information, the merchandise information, and the utilized function information. Then, the transmission record transmitting unit 203 transmits the transmission record to the management apparatus 210 on the manufacturer 120 side via a network.

Further, on the manufacturer 120 side, the management apparatus 210 includes: the transmission record receiving unit 211 for receiving the transmission record; the database updating unit 214 for updating the database; and the data analysis unit 215 for analyzing the received transmission record.

Thus, on the manufacturer 120 side, customer information can be reliably acquired from the IC card at the time of purchasing and installation of the network home appliance 200. Further, also at the time of utilization of the network home appliance 200, utilization information for each function or each merchandise can be managed automatically. This permits marketing or the like, such as analysis that “a speed function is used most frequently in a washing machine while a drying function is used less frequently”. This permits application to merchandise planning or marketing strategy for electric appliances.

Further, this avoids the necessary of complicated customer information management in the prior art, and hence reduces the management and operation cost on the manufacturer 120 side who manages the customer information.

Further, the first-time determination unit 202a determines whether a first-time transmission record has been transmitted from the home appliance 200 to the management apparatus 210 side.

Then, the device control unit 205 brings the home appliance 200 into a usage non-permitted state unless the first-time transmission record is transmitted. This allows the management apparatus 210 side to acquire more reliably the information of the customer who uses the home appliance 200.

in the case of utilization of rental of network home appliance products which is expected to spread in the future, usage status for each customer, each merchandise, or each function can be recognized accurately and hence can be applied also to usage charge calculation. Further, when the customer information is managed on the management apparatus 210 side, service such as predetermined discount can be provided to customers having usage time exceeding a predetermined value.

Here, in the customer management system according to the present invention, when the network home appliance 200 is connected to a home network, IC card information may automatically be acquired from another network home appliance 200 in the home via the home network, and then transmitted to the management apparatus 210 side. In this case, the processing of reading IC card information in the first-time usage of the network home appliance 200 can be avoided in the IC card reading unit 201.

Further, the data configuration of the transmission record described in the present embodiment is illustrative, and hence is not limited to this example. Further, the entire customer information described in the IC card need not be transmitted at each time of transmission of the transmission record. That is, the IC card number may solely be transmitted.

Further, the present embodiment has been described for the case that a network home appliance is used. However, the present invention is not limited to this. That is, a PC or the like may be provided with a similar function so that utilization information of a device other than the network home appliance may be managed for each customer.

### INDUSTRIAL APPLICABILITY

The customer management system according to the present invention is effective especially in a manufacturer who takes charge of manufacturing of network home appliances such as a rice cooker, a washing machine, and an air-conditioner and who performs marketing and merchandise strategy using customer information and usage information.

1. A customer management system comprising a home appliance device connectable to a network and a management apparatus operable to manage information concerning a customer, said home appliance device and said management apparatus being connected to each other via the network,
wherein said home appliance device includes:
a reading unit operable to read the customer information concerning a customer from a recording medium;
a manufacturing number recording unit operable to hold a manufacturing number provided at a time of manufacturing of said home appliance device;
a transmission record preparing unit operable to prepare a transmission record that describes at least one of function information assigned on the basis of a usage form of said home appliance device, the customer information, and the manufacturing number; and
a transmitting unit operable to transmit the transmission record to said management apparatus, and
wherein said management apparatus includes:
a receiving unit operable to receive the transmission record;
a transmission record reading unit operable to read information described in the transmission record; and
an analysis unit operable to analyze the read information.

2. The customer management system according to claim 1,
wherein said analysis unit is operable to analyze a usage status of the function information used in each said home appliance device.

3. The customer management system according to claim 1,
wherein the recording medium is an IC card, so that said home appliance device acquires information recorded in the IC card from another home appliance device which exists in the same home via a home network, and automatically transmits the obtained information to said management apparatus.

4. The customer management system according to claim 1,
wherein the manufacturing number recorded in said manufacturing number recording unit is a global unique number.

5. The customer management system according to claim 1,
wherein said management apparatus further includes:
a customer database operable to hold the customer information recorded in the transmission record having been received;
a merchandise database operable to hold the merchandise information recorded in the transmission record having been received;
an analysis information database operable to hold an analysis result in said analysis unit; and
a record updating unit operable to update the record of the information recorded in said customer database, said merchandise database, and said analysis information database, after the receiving of the transmission record.

6. The customer management system according to claim 5,
wherein said management apparatus further includes
a determination unit operable to determine whether the customer information included in the transmission record is a new one, and
said record updating unit is operable to add and register the customer information into said customer database in the case of being determined as a new one by said determination unit.

7. The customer management system according to claim 1,
wherein said home appliance device further includes
a first-time determination unit operable to determine whether the customer information has been read by said reading unit, at a time of first-time usage,
said transmission record preparing unit is further operable to prepare a first-time transmission record that includes at least the customer information and the manufacturing number, when the read of the customer information by said reading unit is determined as being the first time by said first-time determination unit, and
said transmitting unit is operable to transmit the first-time transmission record to said management apparatus.

8. The customer management system according to claim 7,
wherein said home appliance device further includes
a device control unit operable to bring said home appliance device into a usage permitted state after the first-time transmission record is transmitted by said transmitting unit.

9. A home appliance device connected via a network to a management apparatus provided on a manufacturer side and operable to manage information concerning a customer, said device comprising:
a reading unit operable to read the customer information from a recording medium;
a manufacturing number recording unit operable to hold a manufacturing number provided at a time of manufacturing of said home appliance device;
a transmission record preparing unit operable to prepare a transmission record that describes at least one of function information assigned on the basis of a usage form of said home appliance device, the customer information, and the manufacturing number; and
a transmitting unit operable to transmit the transmission record to the management apparatus.

10. The home appliance device according to claim 9,
wherein said home appliance device further comprises
a first-time determination unit operable to determine whether the customer information has been read by said reading unit, at a time of first-time usage,
said transmission record preparing unit is further operable to prepare a first-time transmission record that includes at least the customer information and the manufacturing number, when the read of the customer information by said reading unit is determined as being the first time by said first-time determination unit, and
said transmitting unit is operable to transmit the first-time transmission record to the management apparatus.

11. The home appliance device according to claim 10,
wherein said home appliance device further comprises
a device control unit operable to bring said home appliance device into a usage permitted state after the first-time transmission record is transmitted by said transmitting unit.

12. A management apparatus that is connected to a home appliance device connectable to a network and that is provided on a manufacturer side and operable to manage information concerning a customer, said apparatus comprising:
a receiving unit operable to receive a transmission record transmitted from the home appliance device;
a transmission record reading unit operable to read information described in the transmission record; and
an analysis unit operable to analyze a usage status of function information used in each home appliance device, on the basis of the information read by said transmission record reading unit.

13. The management apparatus according to claim 12,
wherein said management apparatus further comprises
a first-time determination unit operable to determine whether in the transmission record, a customer is a new one, or the combination of a customer and the home appliance device is a new one, or the home appliance device is a new one.

14. A program used in a home appliance device connected via a network to a management apparatus provided on a manufacturer side and operable to manage information concerning a customer, said program causing a computer to execute:
a reading step of reading the customer information concerning a customer from a recording medium;
a manufacturing number recording step of holding a manufacturing number provided at a time of manufacturing of the home appliance device;
a transmission record preparing step of preparing a transmission record that describes at least one of function information assigned on the basis of a usage form of the home appliance device, the customer information, and the manufacturing number; and
a transmission step of transmitting the transmission record to the management apparatus.

15. The program according to claim 14,
wherein said program further comprises
a first-time determination step of determining whether the customer information has been read at said reading step, at a time of first-time usage, and
wherein at said transmission record preparing step, a first-time transmission record that includes at least the customer information and the manufacturing number is prepared when the read of the customer information at said reading step is determined as being the first time at said first-time determination step, and
at said transmission step, the first-time transmission record is transmitted to the management apparatus.

16. The program according to claim 15,
wherein said program further comprises
a device control step of bringing the home appliance device into a usage permitted state after the first-time transmission record is transmitted at said transmitting step.

17. A program used in a management apparatus that is connected to a home appliance device connectable to a network and that is provided on a manufacturer side and operable to manage customer information, said program causing a computer to execute:
a receiving step of receiving a transmission record transmitted from the home appliance device;
a transmission record reading step of reading information described in the transmission record; and
an analysis step of analyzing a usage status of function information used in each home appliance device, on the basis of the information read at said transmission record reading step.

18. A customer management method used in a home appliance device connected via a network to a management apparatus provided on a manufacturer side and operable to manage information concerning a customer, said method comprising:
a reading step of reading the customer information concerning a customer from a recording medium;
a manufacturing number recording step of holding a manufacturing number provided at a time of manufacturing of the home appliance device;
a transmission record preparing step of preparing a transmission record that describes at least one of function information assigned on the basis of a usage form of the home appliance device, the customer information, and the manufacturing number; and
a transmission step of transmitting the transmission record to the management apparatus.

19. The customer management method according to claim 18,
wherein said customer management method further comprises
a first-time determination step of determining whether the customer information has been read at said reading step, at a time of first-time usage, and
wherein at said transmission record preparing step, a first-time transmission record that includes at least the customer information and the manufacturing number is prepared when the read of the customer information at said reading step is determined as being the first time at said first-time determination step, and
at said transmission step, the first-time transmission record is transmitted to the management apparatus.

20. The customer management method according to claim 19,
wherein said customer management method further comprises
a device control step of bringing the home appliance device into a usage permitted state after the first-time transmission record is transmitted at said transmitting step.

21. A customer management method used in a management apparatus that is connected to a home appliance device connectable to a network and that is provided on a manufacturer side and operable to manage customer information, said method comprising:
a receiving step of receiving a transmission record transmitted from the home appliance device;
a transmission record reading step of reading information described in the transmission record; and
an analysis step of analyzing a usage status of function information used in each home appliance device, on the basis of the information read at said transmission record reading step.
